(19) United States
(12) Patent Application Publication
(10) Pub. No.: US 2010/0290166 A1
(43) Pub. Date: Nov. 18, 2010

(54) Electronic Device with High ESD Protection

(75) Inventors: Lin Lin, Taichung City (TW); Wen-Hung Wang, Fongyuan City (TW); Shyh-Jeng Chen, Dongshi Township (TW); Kun-Feng Tsou, Fongyuan City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: WINTEK CORPORATION, Taichung (TW)

(21) Appl. No.: 12/778,460

(22) Filed: May 12, 2010

(30) Foreign Application Priority Data
May 12, 2009 (TW) 98115742

(51) Int. Cl. H02H 9/04

(52) U.S. Cl. 361/56

(57) ABSTRACT

An electronic device with high electrostatic discharge (ESD) protection is provided. The electronic device includes a touch panel, at least one ESD protection element and a liquid crystal module. When an ESD event occurs at the surrounding of the touch panel, the ESD energy is rapidly discharged to ground via an energy transmission path inside the touch panel. The ESD protection element is connected to the output terminal of the touch panel in parallel to protect the electronic device and its internal circuits.

This application claims the benefit of Taiwan application Serial No. 98115742, filed May 12, 2009, the subject matter of which is incorporated herein by reference.

### BACKGROUND OF THE INVENTION

1. Field of the Invention

The invention relates in general to an electronic device, and more particularly to an electronic device with a touch panel, wherein ESD energy is discharged via an ESD protection element parallel to output terminals of the touch panel for increasing the ESD Susceptibility of the electronic device.

2. Description of the Related Art

Thin film transistor-liquid crystal display (TFT-LCD) has now become a main stream display device. During the manufacturing process of the TFT-LCD, display cells, driving integrated circuits (IC), a backlight module, polarizers and so on, are assembled to form a liquid crystal module (LCM).

The occurrence of electrostatics discharge (ESD) is inevitable during assembly of the liquid crystal module. If a large amount of electrostatic charges is left on the cells and the circuits inside the liquid crystal glass panel, then the internal circuits will be damaged.

According to the current technology, most ESD will flow to the driving IC to be discharge therefrom. However, the driving IC has a critical ESD susceptibility value. Once the ESD is larger than the critical ESD susceptibility value of the driving IC, the ESD will affect or jeopardize the normal operation of the driving IC. In the worse case, the operation of LCD may be abnormal.

As the technology of touch panel becomes mature, more and more electronic devices are equipped with touch panel. Normally, the touch panel is integrated into LCM. However, ESD problem still occurs in the LCM integrated with touch panel.

Examples of the invention disclose the electronic device with at least one ESD protection element integrated with the touch panel. The ESD energy can be discharged to ground via the ESD protection element. As a result, the ESD energy can not flow to the driving IC, so that the driving IC and the LCM are further protected.

### SUMMARY OF THE INVENTION

Example of the invention is directed to an electronic device with high ESD susceptibility. The electronic device includes a touch panel. When an electrostatic discharge (ESD) event occurs, ESD energy is rapidly discharged to ground via an ESD protection element connected to output terminals of the touch panel in parallel to protect the electronic device and its internal circuits.

An exemplary embodiment of the invention provides an electronic device. The electronic device includes a touch panel, at least one ESD protection element and a liquid crystal module. The touch panel includes at least one energy transmission path and at least one output terminal. One terminal of the at least one ESD protection element is connected to an output terminal of the touch panel in parallel and another terminal of the at least one ESD protection element is grounded. When ESD energy is generated, the ESD energy is discharged to ground via the energy transmission path and the ESD protection element. The liquid crystal module is coupled to the touch panel for receiving and processing an electrical signal outputted from the output terminal of the touch panel.

Thus, via parallel connection of the ESD protection element with the output terminal of touch panel, when an ESD energy is generated around or above the touch panel, the ESD protection element and the energy transmission path inside the touch panel avoid the ESD energy from flowing into the liquid crystal module or the driving circuit inside the electronic device, so that the liquid crystal module and the driving circuit are protected and the ESD susceptibility of the electronic device are enhanced.

The invention will become apparent from the following detailed description of the preferred but non-limiting embodiments. The following description is made with reference to the accompanying drawings.

### BRIEF DESCRIPTION OF THE DRAWINGS

FIG. 1 shows an electronic device according to an embodiment of the invention;

FIG. 2 shows a touch panel 120 connected to an ESD protection element in parallel;

FIG. 3 shows another circuit diagram according to the embodiment of the invention, wherein the touch panel has four output pins X+, X−, Y+ and Y−;

FIG. 4 shows still another circuit diagram according to the embodiment of the invention, wherein the touch panel has five output pins UL, UR, WIPER, LL and LR;

FIG. 5 shows yet another circuit diagram according to the embodiment of the invention, wherein the touch panel has seven output pins UL EXCITE, UL SENSE, UR, WIPER, LR, LR EXCITE; and

FIG. 6 shows further another circuit diagram according to the embodiment of the invention, wherein the touch panel has two signal traces X TRACE and Y TRACE.

### DETAILED DESCRIPTION OF THE INVENTION

In one embodiment of the invention, an electronic device having a touch panel includes one or more ESD protection element connected to output terminals of the touch panel in parallel. Thus, when an ESD occurs, the ESD is discharged to ground via the ESD protection elements connected to the output terminals of the touch panel in parallel to enhance the ESD susceptibility of the electronic device.

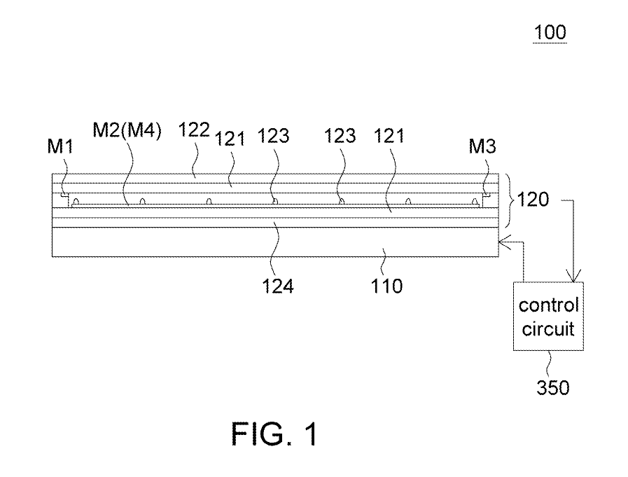

FIG. 1 shows an electronic device according to an embodiment of the invention. As indicated in FIG. 1, the electronic device 100 at least includes a liquid crystal module 110, a touch panel 120 and a control circuit 350. The control circuit 350 processes an output signal outputted from the touch panel 120 and provides a control signal to the liquid crystal module 110.

The liquid crystal module 110 is for example but not limited by a common flat liquid crystal module, such as a liquid crystal module, an organic light emitting diode (OLED) module, an electro-phoretic display (EPD), and an electrowetting display (EWD) module. However, the electronic device 100 may further include other elements which are not illustrated for simplification.

The control circuit 350 includes three functional circuits such as a touch panel controller, a micro controller unit (MCU) and a display driving circuit. As for the foregoing control circuit 350, the touch panel 120 transmits an output signal to the micro controller unit MCU, and then the micro controller unit further provides a control signal to the liquid crystal module 110. Moreover, the foregoing three functional circuits can be integrated into one single control circuit, or any two of the three functional circuits can be integrated into one, and there is no specific restriction imposed here. Besides, the control circuit 350 can be disposed on one of the touch panel 120 and the display panel 110 or outside the touch panel 120 and the display panel 110.

Referring to FIG. 1 again, the touch panel 120 may be a resistive touch panel. The touch panel 120 at least includes a plurality of metal conducting wires M1˜M4, a conductive film 121, a film 122, a spacer 123 and a substrate 124. The details of the metal conducting wires M1˜M4 will be given below. The conductive film 121 is such as a transparent indium tin oxide (ITO) conductive glass.

In FIG. 1, the touch panel 120 is integrated on top of the liquid crystal module 110, but the invention is not limited thereto. For example, in other possible embodiments, the touch panel 120 can also be disposed on the liquid crystal module 110. The substrate 124 of the touch panel 120 can also be used as a top substrate of the liquid crystal module 110. In other words, the substrate 124 of the touch panel 120 is the top substrate of the liquid crystal module 110. Besides, the touch panel 120 can be an independent module which still has electrically and structurally connecting relation with other elements of the electronic device 100.

Besides, the resistive touch panel exemplified above is just an example of touch panel, but in other embodiments, other types of touch panel such as a capacitive touch panel, an optical touch panel are applicable.

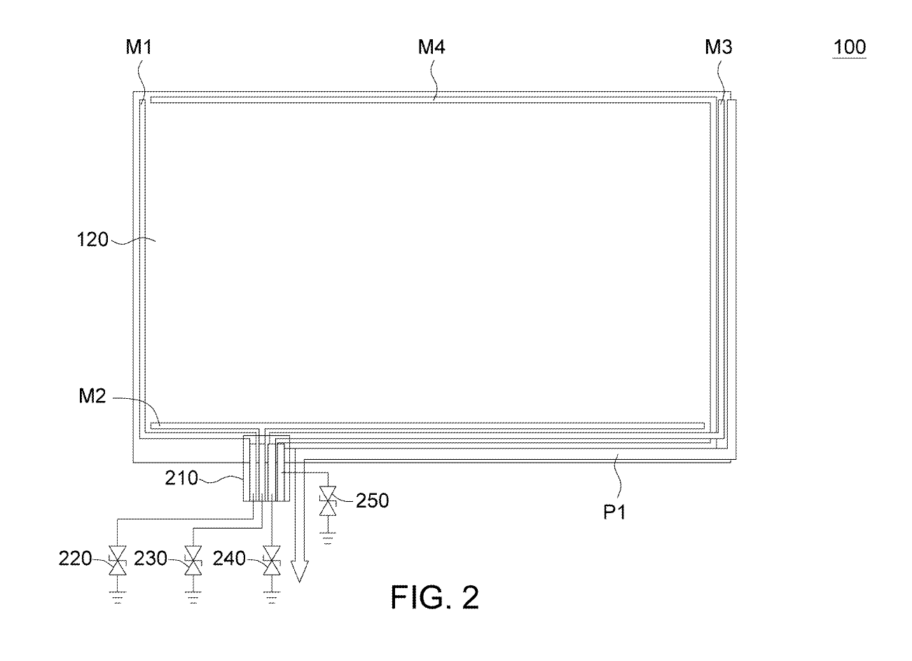

In the present embodiment of the invention, the output terminal of the touch panel 120 is connected to at least one ESD protection element in parallel. FIG. 2 shows the touch panel 120 connected to ESD protection elements in parallel.

As indicated in FIG. 2, the touch panel 120 has four metal conducting wires M1˜M4. These metal conducting wires M1˜M4 may have other possible positions and shapes and FIG. 2 shows one possible example of the metal conducting wires M1˜M4. In principle, the metal conducting wires M1˜M4 are disposed near the edge of the touch panel 120.

The flexible printed circuit (FPC) 210 is a part of the touch panel 120 and connected to the output terminal of the touch panel 120. The flexible printed circuit 210 electrically connects the touch panel 120 to the system (not illustrated) or other part of the electronic device 100. That is, the flexible printed circuit 210 transmits the output signal of the touch panel 120 to the system of the electronic device 100. After the output signal is processed by the system, another control signal is outputted to the liquid crystal module for controlling frame display, such as zoom in/out and the rotation of a frame.

Multiple ESD protection elements 220-250 are connected to the flexible printed circuit 210. The metal conducting wire M1 is connected to the ESD protection element 220 via the flexible printed circuit 210. The metal conducting wire M2 is connected to the ESD protection element 230 via the flexible printed circuit 210. The metal conducting wire M3 is connected to the ESD protection element 240 via the flexible printed circuit 210. The metal conducting wire M4 is connected to the ESD protection element 250 via the flexible printed circuit 210.

In the present embodiment of the invention, the ESD protection element can be selected from a transient voltage suppresser diode (TVS diode), a varistor, or the like.

The TVS diode has the advantages of fast turn-on speed and better protection effect due to the lower turn-on voltage and the clamping voltage thereof.

The varistor is selected due to the following reasons. Firstly the voltage-resistance relationship is non-linear. Secondly the change in resistance is symmetric if voltage increases or decreases. Besides, the varistor can absorb most surges and suppress the abnormal voltage within a safe range, so that the life cycle and the stability of the circuit are further enhanced.

The varistor in ready state has high impedance (as high as several mega-ohms, and can be regarded as an open loop) compared with the electronic device under protection, so that the original characteristics of the circuit will not be affected. However, when a transient surge voltage occurs (that is, a voltage higher than a breakdown voltage of the varistor), the impedance of the varistor will step down (to be as low as several ohms) and result in short-circuiting. As a result, the transient surge voltage will be instantaneously absorbed by the varistor instead of the electronic device or element under protection.

Besides, the varistor has the characteristics of fast response time, superior voltage ratio, highly stable loop voltage, transient voltage absorption and symmetric voltage-current.

When an ESD energy is generated above the electronic device 100 (that is, above the touch panel 120) for example, the ESD energy is rapidly discharged to ground via the metal conducting wires M1˜M4, the flexible printed circuit 210 and the ESD protection elements 220-250. Thus, little or even no ESD energy will be transmitted to the inside of the electronic device 100 (such as driving IC or display cells), so that the ESD susceptibility of the electronic device 100 is largely increased.

As indicated in FIG. 2, the ESD energy is rapidly discharged to ground via the metal conducting wires M3, the flexible printed circuit 210 and the ESD protection element 240, wherein the discharging path is indicated as the ESD discharging path P1.

If the ESD energy is generated at different positions, the ESD energy can be discharged to ground via other ESD protection elements. Besides, the ESD energy can be discharged to ground via multiple metal conducting wires and multiple ESD protection elements simultaneously.

The material of the conducting wires M1˜M4 is not limited to metal, any material capable of fast conducting the ESD may be used.

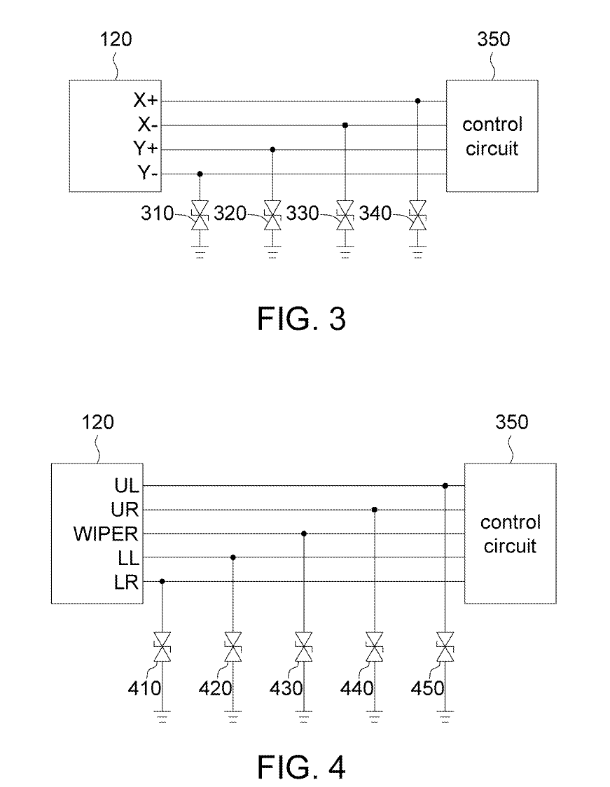

FIG. 3 shows another circuit diagram according to the embodiment of the invention. The touch panel 120 is exemplified by a resistive 4-line touch panel which has four output pins X+, X−, Y+ and Y−. Each of the four ESD protection elements 310-340 is connected to a respective one of the four output pins X+, X−, Y+ and Y− of the touch panel 120 in parallel. In addition, the control circuit 350 is connected to the touch panel 120 for receiving and processing electrical signals outputted from the touch panel 120. The control circuit 350 is an element of the electronic device 100. The control circuit 350 can be disposed on the liquid crystal module or on the touch panel 120.

FIG. 4 shows still another circuit diagram according to the embodiment of the invention. The touch panel 120 is exemplified by a resistive 5-line touch panel, which has five output pins UL, UR, WIPER, LL and LR. Each of the five ESD protection elements 410-450 is connected to a respective one of the five output pins UL, UR, WIPER, LL and LR of the touch panel 120.

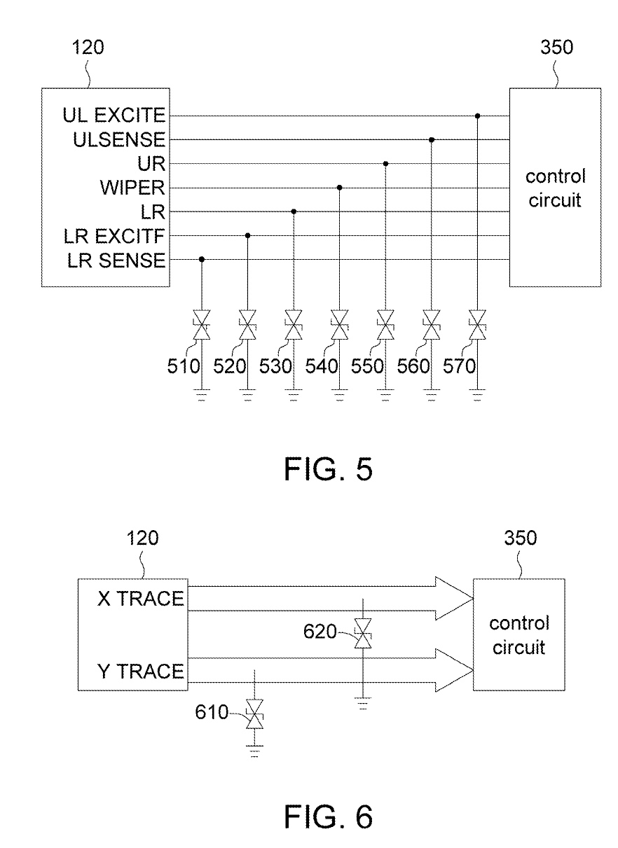

FIG. 5 shows yet another circuit diagram according to the embodiment of the invention. The touch panel 120 is exemplified by a resistive 7-line touch panel, which has seven output pins UL EXCITE, UL SENSE, UR, WIPER, LR, LR EXCITE and LR SENSE. Each of the seven ESD protection elements 510-570 is connected to a respective one of the seven output pins UL EXCITE, UL SENSE, UR, WIPER, LR, LR EXCITE and LR SENSE of the touch panel 120.

FIG. 6 shows further another circuit diagram according to the embodiment of the invention. The touch panel 120 is exemplified by a capacitive touch panel, which has two signal traces X TRACE and Y TRACE.

The signal trace X TRACE denotes a plurality of scan lines arranged along a horizontal direction (X-direction). The signal trace Y TRACE denotes a plurality of sensing lines arranged along a vertical direction (Y-direction). As indicated in FIG. 6, each of the signal traces X TRACE and Y TRACE of the touch panel 120 is connected to a respective one of the ESD protection elements 610-620 in parallel. Further, each scan line in the X-direction is connected to one ESD protection element in parallel and each sensing line in the Y-direction is connected to one ESD protection element in parallel. For example, if there are 10 scan lines in the X-direction, each of the 10 scan lines will be respectively connected to one ESD protection element in parallel.

Similarly, if there are 15 sensing lines in the Y-direction, each of the 15 sensing lines will be respectively connected to one ESD protection element in parallel. Besides, the ESD protection elements 610-620 can also be disposed inside the control circuit 350 such that the capacitance effect caused by the ESD protection elements 610-620 cannot affect the detecting accuracy of the touch panel 120.

On the contrary, for a touch panel without any ESD protection element disposed on the liquid crystal module thereof, the ESD energy will flow to the top electrode plate or the silver epoxy of the liquid crystal module and discharge therefrom. When the ESD energy is 9 KV, the touch panel which has no ESD protection element can still be normally operated. However, once the ESD energy reaches to 10 KV or above, the higher ESD energy will result in a malfunction of the liquid crystal module.

According to the embodiments of the invention, the liquid crystal module can be normally operated, even though the ESD energy reaches up to 15 KV. Therefore, the embodiments of the invention indeed increase the ESD susceptibility of the electronic device.

Furthermore, in embodiments of the present invention, all the output terminals of the touch panel do not need to be connected to the respective one of the ESD protection elements in parallel, but at least one output terminal must be connected to the ESD protection element in parallel.

All electronic devices integrated with touch panel can increase their ESD susceptibility by using the ESD protection elements disclosed in embodiments of the present invention.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An electronic device, comprising:
a touch panel including at least one energy transmission path and at least one output terminal, wherein the output terminal outputs at least one output signal to a control circuit;
at least one ESD protection element having one terminal connected to the output terminal of the touch panel in parallel and another terminal grounded, wherein when an ESD energy is generated, the ESD energy is discharged to ground via the energy transmission path and the ESD protection element; and
a liquid crystal module disposed on one side of the touch panel for receiving at least one control signal outputted from the control circuit.

2. The electronic device according to claim 1, further comprising:
a flexible printed circuit coupled between the output terminal and the control circuit of the touch panel for transmitting the output signal outputted from the output terminal of the touch panel to the control circuit, wherein the ESD protection element is electrically coupled to the flexible printed circuit.

3. The electronic device according to claim 1, wherein the number of the energy transmission path is equal to the number of the output terminal of the touch panel, and the number of the ESD protection element is equal to the number of the output terminal of the touch panel.

4. The electronic device according to claim 1, wherein the ESD protection element is disposed inside the control circuit.

5. The electronic device according to claim 1, wherein the ESD protection element is one of a transient voltage suppresser diode and a varistor.

6. The electronic device according to claim 1, wherein the control circuit is disposed on one of the touch panel and the liquid crystal module.

7. The electronic device according to claim 1, wherein the control circuit is disposed independently outside of the touch panel and the liquid crystal module.

8. The electronic device according to claim 1, wherein the touch panel is one of a resistive touch panel, a capacitive touch panel and an optical touch panel.
